(19) United States
(12) Patent Application Publication
(10) Pub. No.: US 2018/0067653 A1
(43) Pub. Date: Mar. 8, 2018

(54) DE-DUPLICATING MULTI-DEVICE PLUGIN

(71) Applicant: QUEST SOFTWARE INC., Aliso Viejo, CA (US)

(72) Inventors: Tarun Kumar Tripathy, Newark, CA (US); Abhijit Dinkar, San Jose, CA (US)

(73) Assignee: QUEST SOFTWARE INC., Aliso Viejo, CA (US)

(21) Appl. No.: 15/260,200

(22) Filed: Sep. 8, 2016

(51) Int. Cl. G06F 3/06

(52) U.S. Cl. CPC G06F 3/0608; G06F 3/065; G06F 3/067; G06F 3/0619; G06F 3/0641

(57) ABSTRACT

Systems, methods, and devices are disclosed herein for implementing deduplicating multi-device plugin. Methods may include receiving a data storage request identifying a data block for storage in a virtual device, where the virtual device is created by a multiple device driver capable of generating a plurality of virtual devices based on a plurality of underlying physical storage devices and a plurality of remote devices. The methods may also include determining, using one or more processors, whether the data block has already been stored in the virtual device created by the multiple device driver. The methods may further include updating, using the one or more processors, a blockmap based on the determining, the blockmap representing a plurality of data blocks stored in the virtual device.

### TECHNICAL FIELD

The present disclosure relates generally to de-duplication of data, and more specifically to de-duplicating locally available storage devices.

### DESCRIPTION OF RELATED ART

Data is often stored in storage systems that are accessed via a network. Network-accessible storage systems allow potentially many different client systems to share the same set of storage resources. A network-accessible storage system can perform various operations that render storage more convenient, efficient, and secure. For instance, a network-accessible storage system can receive and retain potentially many versions of backup data for files stored at a client system. As well, a network-accessible storage system can serve as a shared file repository for making a file or files available to more than one client system.

Some data storage systems may perform operations related to data deduplication. In computing, data deduplication is a specialized data compression technique for eliminating duplicate copies of repeating data. Deduplication techniques may be used to improve storage utilization or network data transfers by effectively reducing the number of bytes that must be sent or stored. In the deduplication process, unique blocks of data, or byte patterns, are identified and stored during a process of analysis. As the analysis continues, other data blocks are compared to the stored copy and a redundant data block may be replaced with a small reference that points to the stored data block. Given that the same byte pattern may occur dozens, hundreds, or even thousands of times, the amount of data that must be stored or transferred can be greatly reduced. The match frequency may depend at least in part on the data block size. Different storage systems may employ different data block sizes or may support variable data block sizes.

Deduplication differs from standard file compression techniques. While standard file compression techniques typically identify short repeated substrings inside individual files, storage-based data deduplication involves inspecting potentially large volumes of data and identify potentially large sections—such as entire files or large sections of files—that are identical, in order to store only one copy of a duplicate section. In some instances, this copy may be additionally compressed by single-file compression techniques. For example, a typical email system might contain 100 instances of the same one megabyte (MB) file attachment. In conventional backup systems, each time the system is backed up, all 100 instances of the attachment are saved, requiring 100 MB storage space. With data deduplication, the storage space required may be limited to only one instance of the attachment. Subsequent instances may be referenced back to the saved copy for deduplication ratio of roughly 100 to 1.

### SUMMARY

The following presents a simplified summary of the disclosure in order to provide a basic understanding of certain embodiments of the present disclosure. This summary is not an extensive overview of the disclosure and it does not delineate the scope of the present disclosure. Its sole purpose is to present some concepts disclosed herein in a simplified form as a prelude to the more detailed description that is presented later.

Systems, methods, and devices are disclosed herein for implementing a deduplicating multi-device plugin also referred to herein as a multiple device plugin. Methods may include receiving a data storage request identifying a data block for storage in a virtual device, where the virtual device is created by a multiple device driver capable of generating a plurality of virtual devices based on a plurality of underlying physical storage devices and a plurality of remote devices. The methods may also include determining, using one or more processors, whether the data block has already been stored in the virtual device created by the multiple device driver. The methods may further include updating, using the one or more processors, a blockmap based on the determining, the blockmap representing a plurality of data blocks stored in the virtual device.

In some embodiments, the virtual device is accessible by a local machine in which the multiple device driver is installed. In various embodiments, the creating of the virtual device includes generating a remote block device container associated with the virtual device, generating a block device unit within the block device container, and automatically populating a blockmap associated with the block device unit within the block device container. In various embodiments, the determining whether the data block has already been stored in the virtual device further includes generating a representation of the identified data block by fingerprinting the identified data block, looking up the representation of the identified data block in an index of fingerprints of stored data blocks, and determining whether or not the representation of the identified data block exists in a deduplication repository.

In various embodiments, the determining whether the data block has already been stored in the virtual device uses a remote protocol. In some embodiments, the updating of the index includes updating a data block reference count associated with the virtual device. The methods may also include providing the identified data block to a networked storage device. In some embodiments, the networked storage device is a deduplication repository. In various embodiments, the multiple device driver is a Linux-compatible driver. According to some embodiments, the multiple device driver is implemented on a Linux-based local machine.

Also disclosed herein are devices that may include a communications interface configured to be communicatively coupled with a networked storage device and one or more processors configured to receive a data storage request identifying a data block for storage in a virtual device, the virtual device being created by a multiple device driver capable of generating a plurality of virtual devices based on a plurality of underlying physical storage devices and a plurality of remote devices. The one or more processors may also be configured to determine whether the data block has already been stored in the virtual device created by the multiple device driver. one or more processors may also be configured to update a blockmap based on the determining, the blockmap representing a plurality of data blocks stored in the virtual device.

In some embodiments, the virtual device is accessible by a local machine in which the multiple device driver is installed, and the networked storage device is configured to generate a remote block device container associated with the virtual device, generate a block device unit within the block device container, and automatically populate a blockmap associated with the block device unit within the block device container. In various embodiments, the one or more processors are further configured to generate a representation of the identified data block by fingerprinting the identified data block, look up the representation of the identified data block in an index of fingerprints of stored data blocks, and determine whether or not the representation of the identified data block exists in a deduplication repository. According to some embodiments, the one or more processors are configured to determine whether the data block has already been stored in the virtual device using a remote protocol. In various embodiments, the one or more processors are further configured to update a data block reference count associated with the virtual device, and provide the identified data block to a networked storage device.

Further disclosed herein are systems that may include a networked storage device, and a local machine comprising one or more processors configured to receive a data storage request identifying a data block for storage in a virtual device, the virtual device being created by a multiple device driver capable of generating a plurality of virtual devices based on a plurality of underlying physical storage devices and a plurality of remote devices. The one or more processors may also be configured to determine whether the data block has already been stored in the virtual device created by the multiple device driver, and update a blockmap based on the determining, the blockmap representing a plurality of data blocks stored in the virtual device.

In some embodiments, the virtual device is accessible by a local machine in which the multiple device driver is installed, and the networked storage device is further configured to generate a remote block device container associated with the virtual device, generate a block device unit within the block device container, and automatically populate a blockmap associated with the block device unit within the block device container. In various embodiments, the one or more processors are further configured to generate a representation of the identified data block by fingerprinting the identified data block, look up the representation of the identified data block in an index of fingerprints of stored data blocks, and determine whether or not the representation of the identified data block exists in a deduplication repository. In some embodiments, the one or more processors are configured to determine whether the data block has already been stored in the virtual device using a remote protocol. In various embodiments, the one or more processors are further configured to update a data block reference count associated with the virtual device, and provide the identified data block and the updated blockmap to a networked storage device.

### BRIEF DESCRIPTION OF THE DRAWINGS

The disclosure may best be understood by reference to the following description taken in conjunction with the accompanying drawings, which illustrate particular embodiments of the present disclosure.

FIG. 1 illustrates an example of a client system for accessing a deduplication repository, configured in accordance with some embodiments.

FIG. 2 illustrates a particular example of a system that can be used in conjunction with the techniques and mechanisms of the present disclosure.

FIG. 3 illustrates a flow chart of an example of a method for data storage utilizing a deduplication repository, implemented in accordance with some embodiments.

FIG. 4 illustrates a flow chart of an example of a method for implementing a client system for a deduplication repository with a multiple device driver, implemented in accordance with some embodiments.

FIG. 5 illustrates a flow chart of an example of a method for configuring a locally accessible deduplication repository, implemented in accordance with some embodiments.

FIG. 6 illustrates a flow chart of an example of a method for data storage, implemented in accordance with some embodiments.

FIG. 7 illustrates a flow chart of an example of a method for data retrieval, implemented in accordance with some embodiments.

### DESCRIPTION OF PARTICULAR EMBODIMENTS

Reference will now be made in detail to some specific examples of the present disclosure including the best modes contemplated by the inventors for carrying out the present disclosure. Examples of these specific embodiments are illustrated in the accompanying drawings. While the present disclosure is described in conjunction with these specific embodiments, it will be understood that it is not intended to limit the present disclosure to the described embodiments. On the contrary, it is intended to cover alternatives, modifications, and equivalents as may be included within the spirit and scope of the present disclosure as defined by the appended claims.

For example, the techniques and mechanisms of the present disclosure will be described in the context of particular data storage mechanisms. However, it should be noted that the techniques and mechanisms of the present disclosure apply to a variety of different data storage mechanisms. In the following description, numerous specific details are set forth in order to provide a thorough understanding of the present disclosure. Particular example embodiments of the present disclosure may be implemented without some or all of these specific details. In other instances, well known process operations have not been described in detail in order not to unnecessarily obscure the present disclosure.

Various techniques and mechanisms of the present disclosure will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present disclosure unless otherwise noted. Furthermore, the techniques and mechanisms of the present disclosure will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

### Overview

As discussed above, file systems may be backed up and stored in storage systems. Moreover, such backing up of data may include storage systems capable of implementing various deduplication protocols to compress the backed up data. Such storage systems may be referred to herein as deduplication repositories. When implemented, such deduplication repositories may be capable of storing file systems that may be numerous terabytes in size. However, storage systems are often limited in how they may communicate and interface with local computing systems.

As discussed in greater detail below, local computing systems often have multiple device drivers (e.g and drivers in Linux) that are configured to provide virtual devices locally accessible on such computing systems. The virtual devices may be created from one or more independent underlying physical devices. The virtual devices may be arrays of devices that often contain redundancy. The underlying physical devices are often disk drives arranged as a Redundant Array of Independent Disks (RAID array). A multiple device driver may support various different RAID formats or levels, such as level 1 (mirroring), level 4 (striped array with parity device), level 5 (striped array with distributed parity information), level 6 (striped array with distributed dual redundancy information), and level 10 (striped and mirrored).

In various embodiments, multi-device or multiple device drivers can create a virtual device that is comprised of many virtual devices in addition to physical devices. For example a virtual device which is a mirror of two RAIDS virtual devices is one virtual device whose purpose is to mirror the data between its two underlying virtual devices which are internally RAIDS arrays. In another example, a virtual device may be a specialized virtual device that is configured to be a proxy to a physical device that may be implemented at a remote location that may be on another node. In some embodiments, the virtual device may be a proxy to a remote block device unit that is implemented in a remote container of a remote deduplication repository, and the virtual device may be configured to utilize a specialized transfer protocol to facilitate communication with that remote device.

In various embodiments, because multi-device, also referred to herein as multiple device, drivers can create a virtual device that is comprised of multiple underlying virtual devices, various embodiments disclosed herein improve the benefits that are available when using multiple-device drivers. As an example, the use of multiple device drivers may enable mirroring of a virtual device, such as a RAIDS, array with a virtual device that is obtained via a plugin described herein. In this example, a multiple device virtual device of type RAID1 (or mirror) is created, where a first member is a virtual device of type RAIDS, and a second member is a virtual device utilizing a plugin as described herein that includes a remote device controller that proxies a remote block device in a deduplication repository. This allows synchronization of data in the RAIDS array with the data in the remote block device while also providing deduplication functionalities to the remote block device. Moreover, when synchronization completes, the second member may be detached from the multiple device virtual device of type RAID1. In this way, a backup of the RAIDS virtual device may be implemented.

Accordingly, various embodiments disclosed herein configure multiple device drivers to implement remote protocols, thus enabling local computing systems to recognize and utilize deduplication repositories implemented in remote storage systems. In such embodiments, the remote deduplication repositories are discovered and recognized as virtual devices on the local computing system. Accordingly, the deduplication repositories may appear as locally accessible virtual devices. In this way, locally run applications and entities may issue read and write commands to the remote deduplication repositories using, at least in part, the multiple device driver. Communication between the multiple device driver of the local computing system may be implemented and managed using a remote protocol (such as the REMOTE O3E protocol). In this way, a deduplication repository, also referred to herein as a remote deduplication repository, that provides deduplication operations and services may be locally accessible at a local computing system.

### Example Embodiments

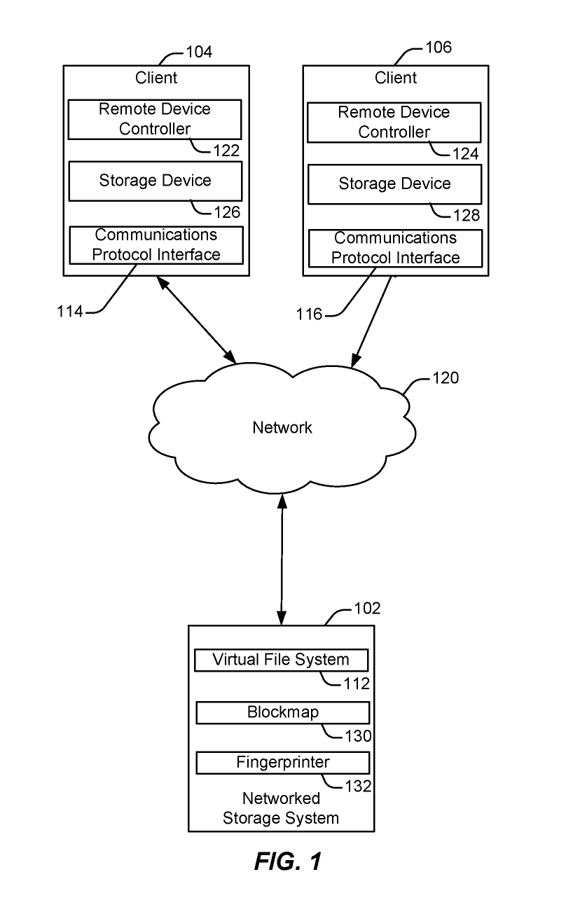

FIG. 1 shows an example of a client system for accessing a deduplication repository, configured in accordance with some embodiments. The network storage arrangement shown in FIG. 1 includes a networked storage system 102 in communication with client systems 104 and 106 via a network 120. The client systems are configured to communicate with the networked storage system 102 via the communications protocol interfaces 114 and 116. The networked storage system 102 is configured to process file-related requests from the client system via the virtual file system 112.

According to various embodiments, the client systems and networked storage system shown in FIG. 1 may communicate via a network 120. The network 120 may include any nodes or links for facilitating communication between the end points. For instance, the network 120 may include one or more WANs, LANs, MANs, WLANs, or any other type of communication linkage. In some implementations, the networked storage system 102 may be any network-accessible device or combination of devices configured to store information received via a communications link. For instance, the networked storage system 102 may include one or more DR6000 storage appliances provided by Dell Computer of Round Rock, Tex.

In some embodiments, the networked storage system 102 may be operable to provide one or more storage-related services in addition to simple file storage. For instance, the networked storage system 102 may be configured to provide deduplication services for data stored on the storage system. Alternately, or additionally, the networked storage system 102 may be configured to provide backup-specific storage services for storing backup data received via a communication link. Accordingly, a networked storage system 102 may be configured as a deduplication repository, and may be referred to herein as a deduplication repository or remote deduplication repository.

According to various embodiments, each of the client systems 104 and 106 may be any computing device configured to communicate with the networked storage system 102 via a network or other communications link. For instance, a client system may be a desktop computer, a laptop computer, another networked storage system, a mobile computing device, or any other type of computing device. Although FIG. 1 shows two client systems, other network storage arrangements may include any number of client systems. For instance, corporate networks often include many client systems in communication with the same networked storage system.

In some embodiments, system 100 may also include remote device controllers 122 and 124. A remote device controller, such as remote device controllers 122 and 124, may be configured to operate in conjunction with a multiple device driver implemented within a client system, such as client systems 104 and 106, and may be further configured to interface with the multiple device driver as a plugin. In some embodiments, the multiple device driver may be a Linux multiple device driver that is configured to support various different modes of operation. In various embodiments, the multiple device driver may support the generation of virtual devices that are entities that may be recognized locally as storage devices. For example, virtual devices may be created from several independent underlying devices. Virtual devices may be redundant arrays of independent disks (RAID arrays). Moreover, the multiple device driver may support various different ways of storing data in the RAID arrays, such as RAID levels 0, 1, 4, 6, and 10.

In some embodiments, the multiple device driver may also support plug-ins that enable other modes of operation of the RAID arrays. Accordingly, as will be discussed in greater detail below, remote device controller may interface with the multiple device driver as a plug-in, and may enable the multiple device driver to recognize a remote device as a virtual device, enable the multiple device driver to support a remote device that uses the special transfer protocol (such as the REMOTE O3E protocol discussed above), and make the remote device available locally at the client system. As will be discussed in greater detail below, such custom virtual devices may be implemented in conjunction with remote devices that are block devices. Moreover, in some embodiments, remote device controllers 122 and 124 may include fingerprinters, similar to fingerprinter 132 implemented on networked storage system 102, which may be configured to generate fingerprints of datablocks, as will be discussed in greater detail below.

In various embodiments, a remote device controller may be implemented within a client system, and may be configured to implement functionalities described in greater detail below. Thus, a remote device controller, such as remote device controller 122, may operate in conjunction with a multiple device driver installed on a client, such as client 104, to implement and support various deduplication and storage operations. As discussed above, the remote device controllers may be implemented with remote devices that use a remote transfer protocol. For example, the remote device controllers may be implemented with networked storage system 102. Accordingly, remote deduplication services may be provided and locally available at client systems such as client systems 104 and 106. As shown in FIG. 1, a single networked storage system 102 may support multiple client systems. In some embodiments, the remote device controllers may be implemented with local storage devices, such as storage devices 126 and 128. In such embodiments, the deduplication services may be provided and implemented at a local storage device, such as a local hard disk.

According to various embodiments, the client systems may communicate with the networked storage system 102 via the communications protocol interfaces 114 and 116. Different client systems may employ the same communications protocol interface or may employ different communications protocol interfaces. The communications protocol interfaces 114 and 116 shown in FIG. 1 may function as channel protocols that include a file-level system of rules for data exchange between computers. For example, a communications protocol may support file-related operations such as creating a file, opening a file, reading from a file, writing to a file, committing changes made to a file, listing a directory, creating a directory, etc. Types of communication protocol interfaces that may be supported may include, but are not limited to: Network File System (NFS), Common Internet File System (CIFS), Server Message Block (SMB), Open Storage (OST), Web Distributed Authoring and Versioning (WebDAV), File Transfer Protocol (FTP), Trivial File Transfer Protocol (TFTP).

In some implementations, a client system may communicate with a networked storage system using the NFS protocol. NFS is a distributed file system protocol that allows a client computer to access files over a network in a fashion similar to accessing files stored locally on the client computer. NFS is an open standard, allowing anyone to implement the protocol. NFS is considered to be a stateless protocol. A stateless protocol may be better able to withstand a server failure in a remote storage location such as the networked storage system 102. NFS also supports a two-phased commit approach to data storage. In a two-phased commit approach, data is written non-persistently to a storage location and then committed after a relatively large amount of data is buffered, which may provide improved efficiency relative to some other data storage techniques.

In some implementations, a client system may communicate with a networked storage system using the CIFS protocol. CIFS operates as an application-layer network protocol. CIFS is provided by Microsoft of Redmond Washington and is a stateful protocol. In some embodiments, a client system may communicate with a networked storage system using the OST protocol provided by NetBackup. In some embodiments, different client systems on the same network may communicate via different communication protocol interfaces. For instance, one client system may run a Linux-based operating system and communicate with a networked storage system via NFS. On the same network, a different client system may run a Windows-based operating system and communicate with the same networked storage system via CIFS. Then, still another client system on the network may employ a NetBackup backup storage solution and use the OST protocol to communicate with the networked storage system 102.

According to various embodiments, the virtual file system layer (VFS) 112 is configured to provide an interface for client systems using potentially different communications protocol interfaces to interact with protocol-mandated operations of the networked storage system 102. For instance, the virtual file system 112 may be configured to send and receive communications via NFS, CIFS, OST or any other appropriate protocol associated with a client system.

In some implementations, the network storage arrangement shown in FIG. 1 may be operable to support a variety of storage-related operations. For example, the client system 104 may use the communications protocol interface 114 to create a file on the networked storage system 102, to store data to the file, to commit the changes to memory, and to close the file. As another example, the client system 106 may use the communications protocol interface 116 to open a file on the networked storage system 102, to read data from the file, and to close the file. In particular embodiments, a communications protocol interface 114 may be configured to perform various techniques and operations described herein. For instance, a customized implementation of an NFS, CIFS, or OST communications protocol interface may allow more sophisticated interactions between a client system and a networked storage system.

According to various embodiments, a customized communications protocol interface may appear to be a standard communications protocol interface from the perspective of the client system. For instance, a customized communications protocol interface for NFS, CIFS, or OST may be configured to receive instructions and provide information to other modules at the client system via standard NFS, CIFS, or OST formats. However, the customized communications protocol interface may be operable to perform non-standard operations such as a client-side data deduplication. For example, similar to protocols such as NFS, CIFS, or OST which are file based protocols, it is possible to support block based protocols such as SCSI (Small Computer Systems interface) or even simple block access. Block access may be implemented to access deduplication repository containers which include block devices which may be remote virtual devices, as will be discussed in greater detail below, that utilize block based protocols. Moreover, a blockmap, such as blockmap 130, may be maintained on the networked storage system 102. With these protocols, a customized communications protocol interface may be operable to perform client-side data deduplication.

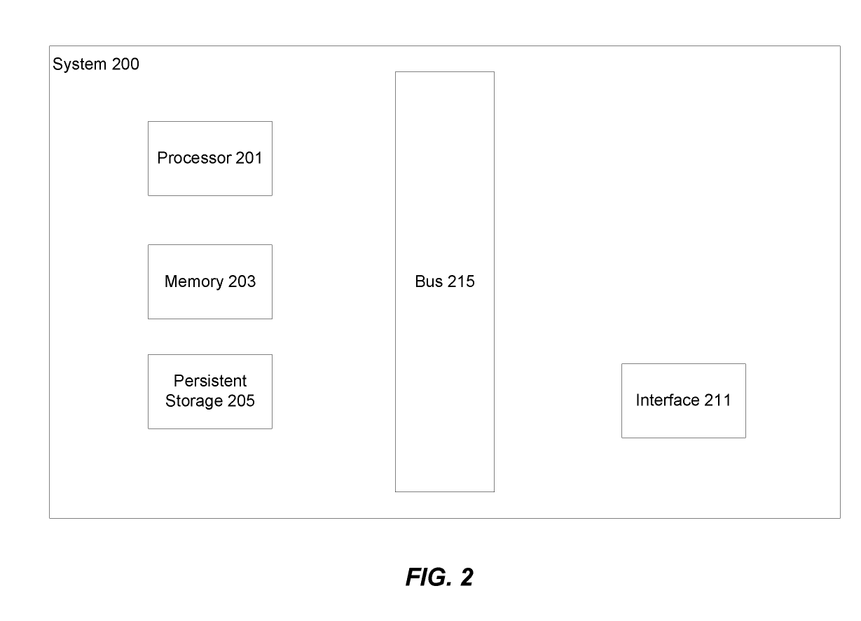

FIG. 2 illustrates a particular example of a device that can be used in conjunction with the techniques and mechanisms disclosed herein. According to particular example embodiments, a device 200 suitable for implementing various components described above, such as remote device controllers as well as networked storage systems. Particular embodiments may include a processor 201, a memory 203, an interface 211, persistent storage 205, and a bus 215 (e.g., a PCI bus). For example, the device 200 may act as a client system such as the client system 104 or the client system 106 shown in FIG. 1. When acting under the control of appropriate software or firmware, the processor 201 is responsible for such tasks such as generating instructions to store or retrieve data on a remote storage system. Various specially configured devices can also be used in place of a processor 201 or in addition to processor 201. The complete implementation can also be done in custom hardware. The interface 211 is typically configured to send and receive data packets or data segments over a network. Particular examples of interfaces the device supports include Ethernet interfaces, frame relay interfaces, cable interfaces, DSL interfaces, token ring interfaces, and the like. Persistent storage 205 may include disks, disk arrays, tape devices, solid state storage, etc.

In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to particular example embodiments, the device 200 uses memory 203 to store data and program instructions and maintain a local side cache. The program instructions may control the operation of an operating system and/or one or more applications, for example. The memory or memories may also be configured to store received metadata and batch requested metadata.

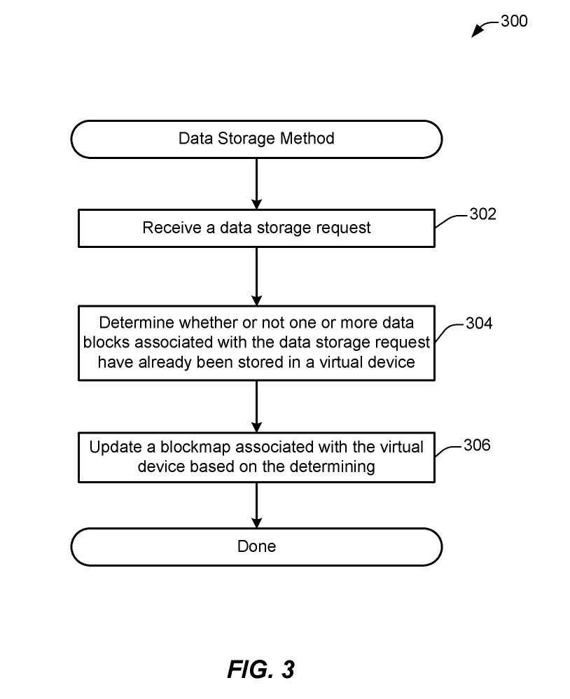

FIG. 3 illustrates a flow chart of an example of a method for data storage in a deduplication repository, implemented in accordance with some embodiments. As discussed above, a deduplication repository may be discovered and locally accessible as a virtual device managed by a multiple device driver. As also discussed above, a deduplication repository includes containers, such as block device containers. In some embodiments, containers may include files which are accessed by protocols such as NFS and CIFS, while other containers may be block device containers which represent a block device or devices which can be accessed using block access protocols, such as SCSI or rudimentary block access. Accordingly, the deduplication repository containers are configured as deduplicating block devices. In some embodiments, deduplication repositories may include containers of two different types. A first type of container may include regular files and are accessed using file access methods. A second type of container may include large sparse files, each mimicking a physical disk volume, that are accessed using block access methods instead of file access methods. As disclosed herein, a specialized and custom transfer protocol may be utilized by a multiple device plugin of the multiple device driver as a way to remotely access containers of the second type. Therefore, locally run applications may issue data storage requests to the locally accessible virtual device that is actually the deduplication repository, which may be implemented as a remote storage system.

Accordingly, method 300 may commence with operation 302 during which a data storage request may be received. In various embodiments the data storage request identifies a data block for storage in a virtual device. As discussed above, the virtual device may have been created by a multiple device driver capable of generating a plurality of virtual devices based on a plurality of underlying storage devices. In some embodiments, the data storage request is received from a locally run application that may be run on a local computing system. The data storage request may be for a virtual device that is actually a remotely implemented deduplication repository.

Method 300 may proceed to operation 304 during which it may be determined whether the data block has already been stored in the virtual device created by the multiple device driver. Accordingly, the deduplication repository, or a representation of a deduplication repository, may be checked to see whether or not the data block has already been stored somewhere in the deduplication repository previously. As will be discussed in greater detail below, this may be accomplished generating a unique representation of the data block, such as a fingerprint, and comparing that representation with a representation of data blocks already stored in the deduplication repository, as may be represented by a blockmap (similar to an inode in a file system) discussed in greater detail below. Accordingly, during operation 304, a representation of the data block may be compared with the blockmap to determine whether or not the data block has previously been stored in the deduplication repository.

Method 300 may proceed to operation 306 during which the blockmap may be updated based on the determining. As discussed above, the blockmap represents a plurality of data blocks stored in the virtual device. Accordingly, the blockmap may be updated to accurately represent the result of the data storage request, which may be the storage of the data block at a particular storage location. As will be discussed in greater detail below, if the data block has been previously stored locally by the remote device controller and/or remotely in the deduplication repository, the blockmap may be updated to include a pointer at the target storage location. The pointer may point to a representation of the previously stored data block. The blockmap may also be updated to include an accurate block count. If the data block has not been previously stored, the representation of the data block may be stored in the blockmap, a pointer may be stored at the target storage location, and a block count may be updated.

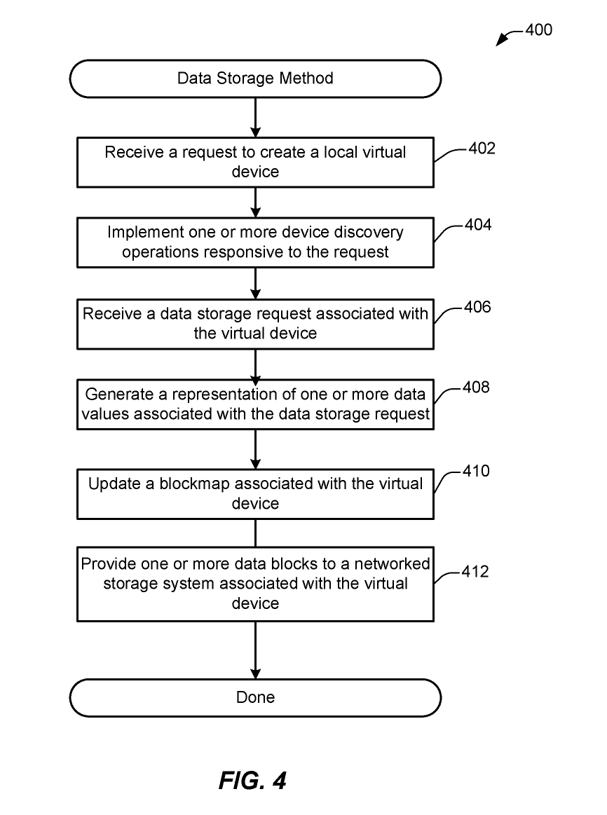

FIG. 4 illustrates a flow chart of an example of a method for implementing a client system for a deduplication repository with a multiple device driver, implemented in accordance with some embodiments. In various embodiments, a multiple device driver may be used to configure and setup a container in the remote deduplication repository (which may be a type or configuration of a block device) as a locally accessible device. Moreover, a remote device controller may be implemented to manage the implementation of data storage and retrieval requests associated with the deduplication repository. As will be discussed in greater detail below, the remote device controller may be implemented locally in the local machine. In some embodiments, the remote device controller is implemented remotely in the deduplication repository.

Accordingly, method 400 may commence with operation 402 during which a local operation implemented on a local machine includes a request to create a virtual device. Such a virtual device may be a local virtual device that may be implemented using RAID 0, 1, 5, etc., as described above, or may be a custom virtual device which is capable of accessing a remote deduplication repository. In various embodiments, such a request may be made on a local machine that may be a local computer system or data processing system. The request may be made by a system component, a locally run application, or a user of the local machine. The request may identify one or more configuration parameters associated with the virtual device, such as an overall storage capacity of the virtual device. In some embodiments, the configuration parameters may include a designated or preset block size. For example, if the storage capacity of the virtual device is 1 GB and the block size is 64 K, then the virtual device may include 16384 blocks.

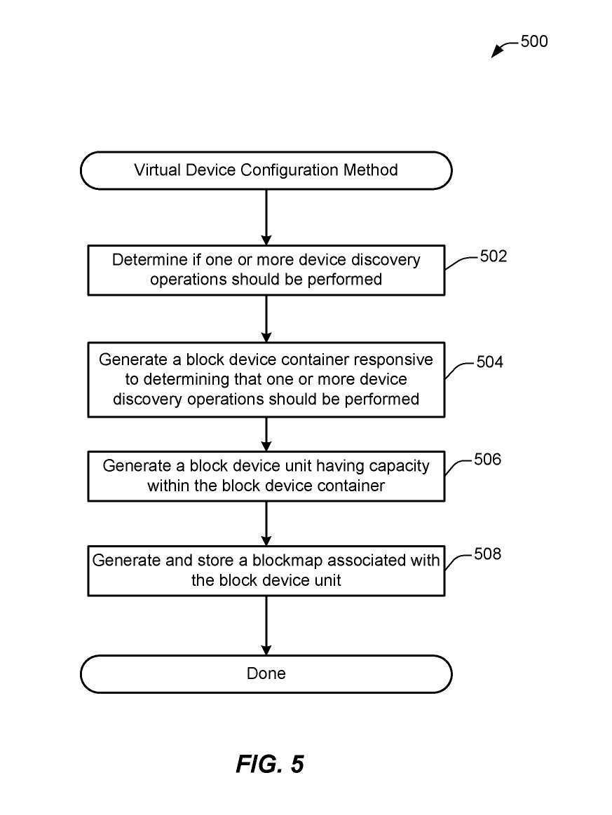

Method 400 may proceed to operation 404 during which one or more device discovery operations may be implemented. As will be discussed in greater detail below with reference to FIG. 5, the local machine may communicate with one or more system components, such as a remote device controller and a networked storage system, to determine whether or not one or more components of the remote device controller and the networked storage system should be configured to implement the virtual device. For example, the networked storage system may allocate storage space to generate a block device container and a block device unit that has storage capacity within the block device container. The networked storage system may also generate and store a blockmap associated with the block device unit. Accordingly, the networked storage system may generate a block device unit that manages and stores data represented locally at the local machine as a virtual device. In various embodiments, the local machine may include the remote device controller that may also update and maintain blockmap information, and may communicate to the networked storage system via a remote protocol. Additional details are discussed in greater detail below with reference to FIG. 5.

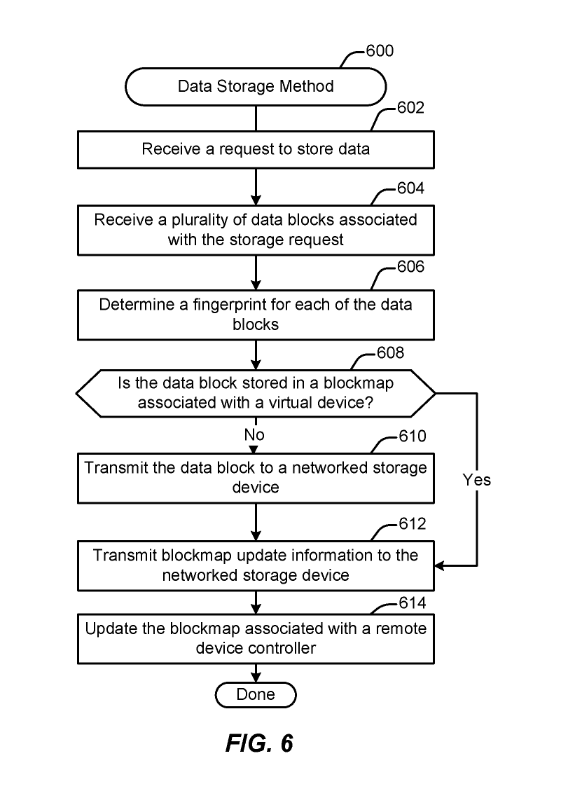

Method 400 may proceed to operation 406 during which a request to store data may be received. In various embodiments, the request may be made by the local machine as data is generated and stored in the virtual device which, in some embodiments, may be presented locally as a local virtual device or hard drive. In some embodiments, the request may be made by other components of the local machine, such as an application implemented and running on the local machine. The request to store data may include various information, such as data values to be stored as well as one or more identifiers that identify a storage location within the virtual device. As will be discussed in greater detail below with reference to FIG. 6, the request may be sent to a system component, such as the remote device controller, and the remote device controller may perform one or more remote storage operations in response to the request.

For example, if a local multiple device driver receives a request, it is of the form {offset, number of blocks} that also includes a pointer to buffers that store the data for those blocks from a local application that is running on top of the multiple device. In various embodiments, a block size of the virtual device, which may be a remote block device, was pre-determined during device discovery. In one example, the block size may be 64 K. Accordingly, the request that may be received by the virtual device (which is part of the configuration of devices managed by the multiple device driver) may be {1048576, 2} and an associated data buffer may be 128 K in size. Accordingly, two 64 K blocks of data at 1 MB offset that may correspond to the 16^{th} and 17^{th} blocks of the virtual device. As will be discussed in greater detail below, if this data is determined to be unique and not already stored in the remote deduplication repository, the data is accelerated to the remote deduplication repository (using a specialized transfer protocol such as the REMOTE O3E protocol) and is written at the 16^{th} and 17^{th} blocks of the remote block device of the remote container.

Method 400 may proceed to operation 408 during which a representation of data associated with the data storage request may be generated. As will be discussed in greater detail below with reference to FIG. 6, the incoming data that was included in the request may be fingerprinted. Such fingerprinting may include applying a secure hash function, such as SHA-1, to the data that has been requested to be stored. By applying such a hash function to the data, a unique set of data values representing the data included in the storage request may be generated in a deterministic manner. The unique set of data values may be also be far smaller than the data included in the storage request and occupy less storage space.

Method 400 may proceed to operation 410 during which a blockmap may be updated. In various embodiments, a system component, such as a remote device controller, may update a stored blockmap based on the data fingerprint generated during operation 408. As will be discussed in greater detail below with reference to FIG. 6, a blockmap may include various data values that represent data stored in a block device unit, and further represent a mapping of logical blocks to physical blocks. For example, the blockmap may include data values that identify a mapping or association between logical block offsets (as well as their respective contents within the block device unit) and physical blocks corresponding to a physical storage location. The respective contents may be determined based on previously determined fingerprints.

In a specific example, a blockmap may identify that logical block X stores data Y, where X is a data block at a particular offset within the block device unit and Y is a fingerprint that represents the contents of that data block. The blockmap may also identify a physical storage location at which the data Y is stored. Moreover, an overall reference count associated with data Y may be maintained. More specifically, the remote device controller may also maintain a reference count that tracks how many times a particular data block, or fingerprint representation of that data block, is referenced within the blockmap. For example, if a block device includes logical blocks 0-9 where each block is 64 K, and the contents of block 0 are the same as the contents of blocks 1, 2, 3, and 4, but blocks 5, 6, 7, 8, and 9 all have unique contents, physical storage utilized may be 6*64 K, where the contents of blocks 0-4 are stored once as one physical block (because they are the same) with a reference count of 4. In this way, a reference count and pointer information associated with each logical block is also stored and maintained as a mapping between logical blocks and physical blocks. Accordingly, the blockmap, as well as an associated reference count, may be updated to indicate that data included in the storage request is stored at a particular storage location also identified by the storage request.

Method 400 may proceed to operation 412 during which a data block may be provided to a remote storage system. A system component, such as the remote device controller, may send the data block as well as the updated blockmap information to another system component, such as a networked storage system. If the data block has already been stored in the networked storage system, just the updated blockmap may be provided. As previously discussed, the data block and updated blockmap may be transmitted via a remote protocol, such as the REMOTE O3E protocol. Once received by the networked storage system, the data block and updated blockmap may be stored as the most current representation of the virtual device.

FIG. 5 illustrates a flow chart of an example of a method for configuring a locally accessible deduplication repository, implemented in accordance with some embodiments. As discussed above, the deduplication repository may be implemented such that it is discovered locally at a local machine as a locally accessible virtual device that is a block device. In various embodiments, one or more local operations may be implemented by, for example, a multiple device driver and a remote device controller, to generate and configure at least a portion of a remote storage system as a locally accessible deduplication repository that may be a particular type or configuration of a block device.

Accordingly, method 500 may commence with operation 502 during which it may be determined if device discovery should be performed. In various embodiments, such a determination may be made based on whether or not a local virtual device has been configured and discovered locally, as well as remotely at a networked storage device that may be used to implement the local virtual device. Accordingly, if the local virtual device has not been discovered and required initial setup and configuration, method 500 may proceed to operation 504.

Method 500 may proceed to operation 504 during which a block device container may be generated. As similarly discussed above, a block device container may be created by sending a request to the deduplication repository. This request is a remote procedure call implemented in the specialized transfer protocol. Accordingly, the block device container, in conjunction with the block device unit discussed in greater detail below, makes the storage locations associated with the device accessible by other system components.

Method 500 may proceed to operation 506 during which a block device unit having capacity within the container may be generated. In various embodiments, the block device unit may be internally implemented by the deduplication repository as a sparse file that has a designated capacity that may be determined based on one or more designated parameters. For example, the block device unit may have a total size initially specified by configuration parameters associated with the local virtual device, and may be partitioned into data blocks each of sizes also specified by the configuration parameters. In this way, the contents of the block device container and unit may be configured and generated per the request from the local virtual device using a specialized configuration of remote procedure calls implemented in a specialized transfer protocol such as the REMOTE O3E protocol.

Method 500 may proceed to operation 508 during which a blockmap may be generated and stored. In various embodiments, a blockmap may be generated that characterizes and identifies the current contents of the block device unit. The blockmap may be automatically generated as part of the creation of the block device unit, and may include a mapping that identifies what data values are stored in what storage locations or offsets. Initially, and upon creation, the block device unit may be empty and store no data or a default value which may be all zeros, and the blockmap may be configured to identify such default values.

FIG. 6 illustrates a flow chart of an example of a method for data storage, implemented in accordance with some embodiments. The method 600 may be performed as part of a procedure in which data is transmitted from a client system to a networked storage system for storage. The method 600 may be performed on a client system, such as the client system 104 and client system 106 shown in FIG. 1. In particular embodiments, the method 600 may be performed in association with a communications protocol interface configured to facilitate interactions between the client machine and the networked storage system. For instance, the method 600 may be performed in association with the communications protocol interface 114 and 116 shown in FIG. 1.

At 602, a request to store data is received. In some embodiments, the request may be received as part of a data storage operation executed by a client system which may be a local machine. For instance, the client system may initiate the request in order to store data in a virtual device or virtual drive that has been configured and discovered on the local machine, and is locally accessible by the local machine. As previously discussed, the virtual device may correspond to a deduplication repository that is implemented remotely. As discussed above, the request may be received at a remote device controller. According to various embodiments, the request may be generated by a processor or other module on the client system. In some embodiments, the request may arrive from a file system or an application which may be running on a client system, and the request may be a block device request which has a form of device offset and number of blocks. The request may also identify various metadata associated with a storage operation.

At 604, a plurality of data blocks associated with the storage request is received. The plurality of data blocks may include data designated for storage. For instance, the data blocks may include the contents of a file of the overlying file system using the multiple device driver and associated virtual device.

At 606, a fingerprint is determined for each of the data blocks. According to various embodiments, the fingerprint may be determined by a fingerprinter. In various embodiments, the fingerprint may be a hash value generated using a hash function such as MD5 or SHA-1. In some embodiments, the fingerprinter may be implemented locally at a local computer system which may be a client system. Accordingly, a data block having a fixed block size may be used as an input to the fingerprinter, which may generate a SHA-1 hash value based on the data block.

At 608, a determination is made as to whether the data block is stored in a blockmap. As previously discussed, such a determination may be made by the remote device controller which may be implemented at the client system. According to various embodiments, the determination may be made at least in part by using the data block fingerprint determined by the fingerprinter at operation 608 to query the blockmap. For example, the blockmap may include an index of data block fingerprints for data blocks stored in the deduplication repository. The data block fingerprint determined at operation 608 may be used to query this index. For example, the generated fingerprint may be compared with entries of the index of fingerprints to determine if a match has been found. Such an index of fingerprints may be maintained at the networked storage system which may be a deduplication repository. If a match is found, it may be determined that the data block is already stored in the blockmap and method 600 may proceed to operation 612. If a match is not found, it may be determined that the data block has not been stored in the blockmap, and method 600 may proceed to operation 610.

At 610, the data block may be transmitted to a networked storage device if the data block is not stored in the blockmap at the client system. Accordingly, the data block may be transmitted to a networked storage device that is used to implement the deduplication repository associated with the virtual device for which a data storage operation has been requested. In some embodiments, a fingerprint of the data block may be transmitted. As discussed above, the fingerprint may include less data values than the entire data block, and may enable the transmission of a representation of the data block using less time and bandwidth then transmission of the entire data block.

At 612, blockmap update information is transmitted to the networked storage system. According to various embodiments, the blockmap update information may be used for updating a blockmap stored at the networked storage system as part of the deduplication repository. Accordingly, the blockmap update information may replace or update an existing blockmap stored in the deduplication repository so that the updated blockmap accurately represents storage of the data block associated with the data storage request.

For example, if it is determined that the data block is already stored on the networked storage system, then the blockmap update information may include new blockmap entries that point to the existing data block. In this way, references to the existing data block are maintained and the data block is not unlinked (i.e. deleted) even if other references to the data block are removed. As another example, if instead it is determined that the data block is not already stored on the networked storage system, then the blockmap update information may include new blockmap entries that point to the storage location of the new data block transmitted at operation 610. For instance, the blockmap entry may include a data store ID associated with the storage location of the new data block. In this way, data blocks for block device units may be stored in various data stores.

Accordingly, at 614, the blockmap associated with the remote device controller is updated. According to various embodiments, the blockmap may be updated to reflect information describing the storage of each of the data blocks received at operation 604. Depending on factors such as the existing contents of the blockmap, the blockmap may be updated in various ways. In a first example, updating the blockmap may involve adding the data block itself and/or metadata describing the data block to the blockmap. For instance, the data block data and/or the data block fingerprint may be added to the blockmap. Other information that may be added may include, but is not limited to: the data block length and/or the data block offset. In a second example, updating the blockmap may involve removing information from the blockmap and updating new information. In some embodiments, this may happen when there are overwrites.

In a third example, updating the blockmap may involve altering or updating information in the blockmap. For instance, data block metadata information associated with the data block stored in the blockmap may be updated to reflect the storage of a data block that already existed in the blockmap. The data block metadata may include information such as a number of times the data block has been stored and/or requested, date and/or time information associated with storage and/or retrieval requests, and other types of data block access information.

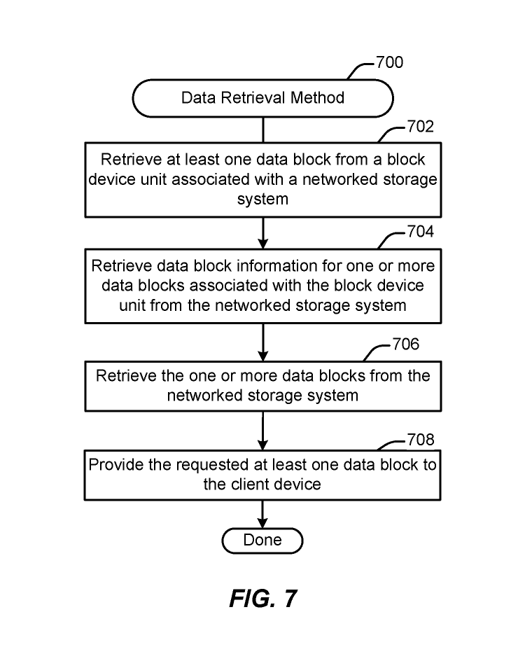

FIG. 7 illustrates a flow chart of an example of a method for data retrieval, implemented in accordance with some embodiments. The method 700 may be performed at a client system such as the client system 104 and client system 106 shown in FIG. 1. The method 700 may be performed in order to retrieve information from a networked storage system. For instance, a processor at client system 104 may issue an instruction to the communications protocol interface 114 to retrieve a file.

At 702, a request to retrieve at least one data block from a block device unit associated with a networked storage system is received. According to various embodiments, the request may be received at a remote device controller which may be implemented in a client system. As discussed with respect to FIG. 1, the remote device controller may be configured to communicate with a networked storage system used to implement a deduplication repository via a communications protocol interface, such as communications protocol interface 114 may be operable to communicate via a block access protocol. In particular embodiments, the request to retrieve the data blocks of a block device unit may be received as part of the execution of an application implemented on the client system, which may be a local machine.

At 704, data block information for one or more data blocks associated with the file is retrieved from the networked storage system. According to various embodiments, the data block information may be retrieved by transmitting and receiving communications through the communications protocol interface. In some embodiments, the data block information retrieved at operation 704 may be used to identify one or more data blocks. For instance, the data block information retrieved at operation 704 may include, but is not limited to: a fingerprint associated with the data block, the length of the data block, and a device offset that indicates where in the requested device the data block is located.

In some implementations, the data block information retrieved at operation 704 may be retrieved by identifying the device requested at operation 702 to the networked storage system. Such block identification information may be used by the networked storage system to look up one or more entries for the device in a blockmap at the networked storage system. In some embodiments, a remote device controller implemented at a client system may use the data block information to look up one or more entries for the device in a blockmap at the client system, and may forward a request for one or more specific data blocks based on the results of the look up.

At 706, the data block is retrieved from the networked storage system. According to various embodiments, retrieving the data block from the networked storage system may involve transmitting a data block request message to the networked storage system. The data block request message may include, for instance, the data block fingerprint received at operation 704 or some other data block identifier. In response to the data block request message, the networked storage system may be operable to transmit the data block to the client system. In particular embodiments, the data block may be received at the client system by the communications protocol interface which may communicate with the networked storage system via a server protocol module and TCP/IP interfaces.

At 708, the requested file is provided at the client system. According to various embodiments, providing the requested data blocks of a virtual device, that is a block device, to the client system may involve combining one or more retrieved data blocks to satisfy the request received at 702. For instance, the data block device offset information retrieved at operation 704 may be used to order and position the data blocks within a block device unit included in a block device container of a deduplication repository. The requested data blocks retrieved may then be provided to one or more components of the client system such as a memory location, a persistent storage module, or a processor.

Because various information and program instructions may be employed to implement the systems/methods described herein, the present invention relates to non-transitory machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

Although many of the components and processes are described above in the singular for convenience, it will be appreciated by one of skill in the art that multiple components and repeated processes can also be used to practice the techniques of the present invention.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

What is claimed is:

1. A method comprising:
receiving a data storage request identifying a data block for storage in a virtual device, the virtual device being created by a multiple device driver capable of generating a plurality of virtual devices based on a plurality of underlying physical storage devices and a plurality of remote devices;
determining, using one or more processors, whether the data block has already been stored in the virtual device created by the multiple device driver; and
updating, using the one or more processors, a blockmap based on the determining, the blockmap representing a plurality of data blocks stored in the virtual device.

2. The method of claim 1, wherein the virtual device is accessible by a local machine in which the multiple device driver is installed.

3. The method of claim 2, wherein the creating of the virtual device comprises:
generating a remote block device container associated with the virtual device;
generating a block device unit within the block device container; and
automatically populating a blockmap associated with the block device unit within the block device container.

4. The method of claim 1, wherein the determining whether the data block has already been stored in the virtual device further comprises:
generating a representation of the identified data block by fingerprinting the identified data block;
looking up the representation of the identified data block in an index of fingerprints of stored data blocks; and
determining whether or not the representation of the identified data block exists in a deduplication repository.

5. The method of claim 4, wherein the determining whether the data block has already been stored in the virtual device uses a remote protocol.

6. The method of claim 4, wherein the updating of the index comprises:
updating a data block reference count associated with the virtual device.

7. The method of claim 6 further comprising:
providing the identified data block to a networked storage device.

8. The method of claim 7, wherein the networked storage device is a deduplication repository.

9. The method of claim 1, wherein the multiple device driver is a Linux-compatible driver.

10. The method of claim 9, wherein the multiple device driver is implemented on a Linux-based local machine.

11. A device comprising:
a communications interface configured to be communicatively coupled with a networked storage device; and
one or more processors configured to:
receive a data storage request identifying a data block for storage in a virtual device, the virtual device being created by a multiple device driver capable of generating a plurality of virtual devices based on a plurality of underlying physical storage devices and a plurality of remote devices;
determine whether the data block has already been stored in the virtual device created by the multiple device driver; and
update a blockmap based on the determining, the blockmap representing a plurality of data blocks stored in the virtual device.

12. The device of claim 11, wherein the virtual device is accessible by a local machine in which the multiple device driver is installed, and wherein the networked storage device is configured to:
generate a remote block device container associated with the virtual device;
generate a block device unit within the block device container; and
automatically populate a blockmap associated with the block device unit within the block device container.

13. The device of claim 11, wherein the one or more processors are further configured to:
generate a representation of the identified data block by fingerprinting the identified data block;
look up the representation of the identified data block in an index of fingerprints of stored data blocks; and
determine whether or not the representation of the identified data block exists in a deduplication repository.

14. The device of claim 13, wherein the one or more processors are configured to determine whether the data block has already been stored in the virtual device using a remote protocol.

15. The device of claim 13, wherein the one or more processors are further configured to:
update a data block reference count associated with the virtual device; and
provide the identified data block to a networked storage device.

16. A system comprising:
a networked storage device; and
a local machine comprising one or more processors configured to:
receive a data storage request identifying a data block for storage in a virtual device, the virtual device being created by a multiple device driver capable of generating a plurality of virtual devices based on a plurality of underlying physical storage devices and a plurality of remote devices;
determine whether the data block has already been stored in the virtual device created by the multiple device driver; and
update a blockmap based on the determining, the blockmap representing a plurality of data blocks stored in the virtual device.

17. The system of claim 16, wherein the virtual device is accessible by a local machine in which the multiple device driver is installed, and wherein the networked storage device is configured to:
generate a remote block device container associated with the virtual device;
generate a block device unit within the block device container; and
automatically populate a blockmap associated with the block device unit within the block device container.

18. The system of claim 16, wherein the one or more processors are further configured to:
generate a representation of the identified data block by fingerprinting the identified data block;
look up the representation of the identified data block in an index of fingerprints of stored data blocks; and
determine whether or not the representation of the identified data block exists in a deduplication repository.

19. The system of claim 18, wherein the one or more processors are configured to determine whether the data block has already been stored in the virtual device using a remote protocol.

20. The system of claim 18, wherein the one or more processors are further configured to:
update a data block reference count associated with the virtual device; and
provide the identified data block and the updated blockmap to a networked storage device.
